(19) United States
(12) Patent Application Publication
(10) Pub. No.: US 2008/0278962 A1
(43) Pub. Date: Nov. 13, 2008

(54) Light System For a Vehicle Headlight Unit

(75) Inventors: Augustinus Gregorius Henricus Meijers, Eindhoven (NL); Edwin Van Lier, Eindhoven (NL); Wouter Petrus Kaandorp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,911

(22) PCT Filed: Jun. 27, 2005
(86) PCT No.: PCT/IB2005/052114

§ 371 Date: Dec. 19, 2006

(30) Foreign Application Priority Data
Jun. 30, 2004 (EP) 04103067.7

(51) Int. Cl. B60Q 1/00

(52) U.S. Cl. 362/539

(57) ABSTRACT

Light system for a vehicle headlight unit, the system comprising a light source (11), a lamp reflector (12) and a substantially rod-shaped transparent light guide (2), wherein the reflector (12) projects light from the light source (11) into the light guide (2), the light guide comprises a glass guide part (21) and a plastic guide part (22), and the glass guide part (21) extends between the light source (11) and the plastic part (22).

The invention relates to a light system for a vehicle headlight unit, tie system comprising a light source, a lamp reflector and a substantially rod-shaped transparent light guide, wherein during operation of the system the reflector projects light from the light source into the light guide.

A light system of this type is known in the art and is currently sold by Hella KGaA Hueck & Co. as CELIS® Light Guide Position Lamps. The position (or parking) light system comprises a 12V-10 W halogen lamp, which projects its light into a bundle of flexible fibreglass light guides passed through to a separate circular glass light rod with a prism-optical pattern, which circular light rod is located around a xenon headlamp in the vehicle headlight unit. The present invention also proposes use of a halogen incandescent lamp having an integrated reflector.

It is an object of the invention to provide an improved or efficient low-cost light system of the type described above.

According to the invention, the light guide comprises a glass guide part and a plastic guide part, wherein the glass guide part extends between the light source and the plastic part. The glass guide part insulates the plastic guide part from the heat of the light source, so that deformation or melting is prevented. Furthermore, the glass guide part mixes the light from the light source before it enters the plastic guide part. In this manner, the larger part of the light guide, and in particular the ring-shaped part, can be made of inexpensive plastic which can be easily produced as one piece. The plastic may contain, for instance, transparent polymethyl methacrylate or polycarbonate. The glass part of the guide preferably has a polygonal, such as a square or a hexagonal, cross-section for good light-mixing properties. The glass part preferably has a length of more than 5 times its width, so that light will not escape from the glass rod at the sides. This length may be, for instance, at least 40 mm, with a width of 8 mm.

The glass is preferably optical glass, such as BK7, or low-iron oxide glass, in order to minimize the loss of light. The glass part and the plastic part are preferably glued together by means of an optical glue. In an alternative embodiment, a small gap is kept between the glass part and the plastic part, so that extra heat insulation is obtained.

The glass guide part is preferably provided with a color filter. In one embodiment, said filter comprises an infrared blocking filter preventing the radiating heat of the lamp from travelling into the plastic part of the light guide. The preferred blocked wavelength range is 800 to 2500 nm. In an additional embodiment, said filter comprises a blue light-transmitting filter. It enables the yellowish light of the position light to be matched with the bluish light of the xenon headlights that it surrounds. The filter may be a reflection filter or an absorption filter, and the filter may have a light-filtering coating on the end surface of the glass guide part. Alternatively, the filter may be constituted by the glass guide part itself, containing a light-filtering compound. The use of a reflection filter has the advantage that the heat of the lamp is not introduced into the guide due to conduction.

The glass guide part preferably extends past the focal point of the lamp reflector, so that this centre of heat development is located in the glass part in order to prevent the plastic part from further deforming or melting. The glass guide part also has a length which is sufficient to allow conducted heat to radiate at the sides, so that not too much heat reaches the plastic part.

The invention will be elucidated, by way of example, with reference to the drawing, wherein:

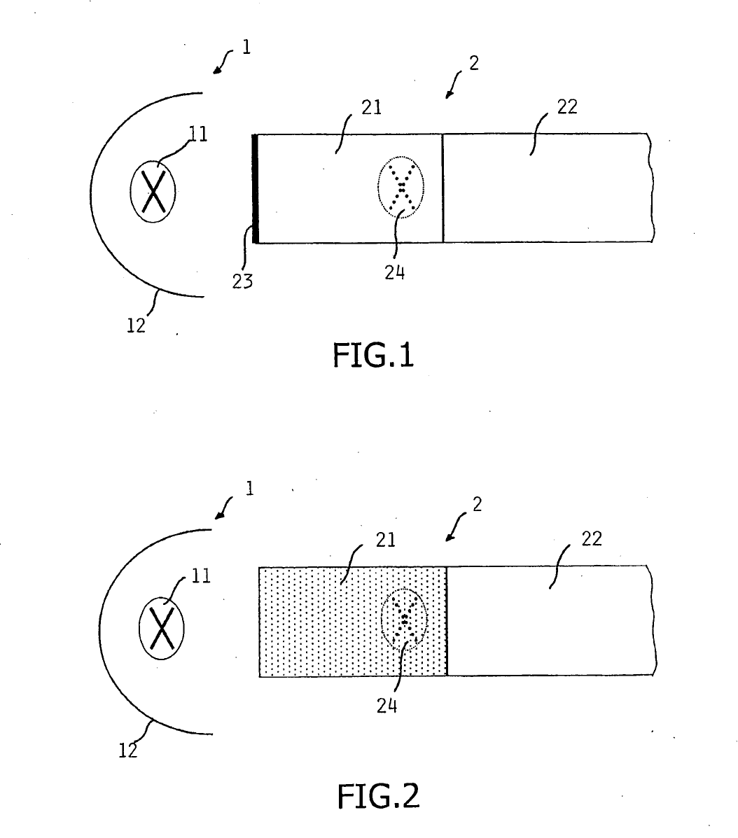

FIG. 1 is a schematic view of a first embodiment of a light system according to the invention; and

FIG. 2 is a schematic view of a second embodiment of a light system according to the invention.

FIGS. 1 and 2 show an automotive position light system comprising a lamp 1 which is placed in front of the outer end of a transparent light guide 2. The lamp 1 comprises a light source 11, for instance, a 12V, 10 W incandescent halogen lamp, and a reflector 12. The light source 11 and the reflector may be integrated. The light guide 2 comprises a glass rod part 21 and a plastic rod part 22 located adjacent one another.

The plastic rod 22 is only partially shown in the Figures, and further comprises an integrated plastic in cross section circular rod at its outer end (not shown). Said circular rod has a prism-optical pattern, so that the light guided through the light guide 2 is coupled out of the circular rod, similarly as in the known CELIS® Light Guide Position Lamps. The circular rod extends around one of the vehicle head lights, as is known from the BMW® 5 and 7 automobile series.

The reflector 12 projects the light from the light source 11 into the glass rod 21 towards the focal point 24. The light source 11 is a primary heat source, and its projection 24 may be regarded as a secondary heat source. The glass rod part 21 acts as heat insulation between the primary heat source 11 and the plastic rod part 22. Furthermore, the glass rod part extends past the projection 24, so that the plastic will not deform or melt due to the secondary heat source 24.

In FIG. 1, the glass rod part 21 is provided with a filter coating 23. In FIG. 2, the glass rod part 21 is provided with a filtering compound, so that it forms a filter by itself. In both cases, the filter is both infrared-blocking and blue light-transmitting. The beat insulation between the primary heat source 11 and the plastic rod part is further improved by providing an infrared filter. The blue light-transmitting property will match the color of the position light with the color of the xenon headlights.

It will be appreciated that many variations within the scope of the invention are possible, and that the embodiments described hereinbefore are merely examples.

1. A light system for a vehicle headlight unit, the system comprising a light source (11), a lamp reflector (12) and a substantially rod-shaped transparent light guide (2), wherein during operation of the system the reflector (12) projects light from the light source (11) into the light guide (2), characterized in that the light guide (2) comprises a glass guide part (21) and a plastic guide part (22), wherein the glass guide part (21) extends between the light source (11) and the plastic part (22).

2. A light system as claimed in claim 1, wherein the glass guide part (21) is provided with a color filter.

3. A light system as claimed in claim 2, wherein said filter comprises an infrared blocking filter.

4. A light system as claimed in claim 2, wherein said filter comprises a blue light-transmitting filter.

5. A light system as claimed in claim 2, wherein said filter is a coating (23) on an end surface of the glass guide part (21).

6. A light system as claimed in claim 2, wherein said filter is constituted by the glass guide part (21) containing a light-filtering compound.

7. A light system as claimed in claim 1, wherein the glass guide part (21) extends past the focal point (24) of the lamp reflector (12).

8. A light system as claimed in claim 1, wherein the light source (11) is a halogen lamp.

9. A light system as claimed in claim 1, wherein the plastic is polymethyl methacrylate or polycarbonate.

10. A light system as claimed in claim 1, wherein the plastic guide part (22) comprises a ring-shaped emission part at one end.

11. A light system as claimed in claim 10, wherein the system further comprises an automotive headlight, and the ring-shaped emission part surrounds said headlight.
